(19) United States
(12) Patent Application Publication
(10) Pub. No.: US 2022/0126456 A1
(43) Pub. Date: Apr. 28, 2022

(54) ROBOT, ROBOT OPERATING METHOD, AND NON- TRANSITORY COMPUTER-READABLE MEDIUM

(71) Applicant: NEC Corporation, Minato-ku, Tokyo (JP)

(72) Inventor: Satomi MATSUMURA, Tokyo (JP)

(73) Assignee: NEC Corporation, Minato-ku, Tokyo (JP)

(21) Appl. No.: 17/431,265

(22) PCT Filed: Oct. 17, 2019
(86) PCT No.: PCT/JP2019/040931

§ 371 Date: Aug. 16, 2021

(30) Foreign Application Priority Data
Feb. 19, 2019 (JP) 2019-027468

(51) Int. Cl. B25J 13/08; A62C 27/00; G05D 1/02

(52) U.S. Cl. CPC B25J 13/08; G05D 1/0231; A62C 27/00

(57) ABSTRACT

A robot capable of causing the robot to perform a plurality of different operations with a laser light is provided. The robot includes a controller, n operating units corresponding to n functions, and a laser detector. n is an integer equal to or higher than two. The laser detector detects a radiated laser light and an irradiated location where the radiated laser light is irradiated. The controller performs a control that causes different operating units to operate in accordance with the irradiated location detected by the laser detector.

### TECHNICAL FIELD

The present disclosure relates to a robot, a robot operating method and a program.

### BACKGROUND ART

In Patent Literature 1, a technology is disclosed in which a robot executes a command according to a reflecting trace of a laser pointer.

### CITATION LIST

### Patent Literature

### [Patent Literature 1]

Japanese Unexamined Patent Application Publication No. 2005-52961

### SUMMARY OF INVENTION

### Technical Problem

However, the technology disclosed in Patent Literature 1 can only cause a robot to perform one kind of operation although the technology can instruct the robot to operate based on a position designated to the robot with a laser pointer.

It is an object of the present disclosure to provide a robot, a robot operating method and a program capable of causing the robot to perform a plurality of different operations with a laser light.

### Solution to Problem

A robot according to a first aspect of the present disclosure includes a plurality of operating units corresponding to a plurality of functions, a laser detecting unit configured to detect a radiated laser light and an irradiated location where the radiated laser light is irradiated, and a control unit, wherein the control unit performs a control that causes different operating units to operate in accordance with the irradiated location detected by the laser detecting unit.

A robot operating method according to a second aspect of the present disclosure is an operating method for a robot including a plurality of operating units corresponding to a plurality of functions, the operating method including a detecting step of detecting a radiated laser light and an irradiated location where the radiated laser light is irradiated, and a control step of performing a control that causes different operating units to operate in accordance with the irradiated location detected by the detecting step.

A program according to a third aspect of the present disclosure is a program causing a control computer of a robot including a plurality of operating units corresponding to a plurality of functions to perform one step of a step of inputting a detection result of a radiated laser light and detecting an irradiated location where the radiated laser light is irradiated and a step of inputting a detection result of an irradiated location where the radiated laser light is irradiated, and a step of performing a control that causes different operating units to operate in accordance with the irradiated location.

### Advantageous Effects of Invention

According to the present disclosure, a robot, a robot operating method and a program capable of causing the robot to perform a plurality of different operations with a laser light can be provided.

### BRIEF DESCRIPTION OF DRAWINGS

FIG. 1 is a functional block diagram showing one configuration example of a robot according to a first example embodiment.

FIG. 2 is an external view showing one configuration example of a fire extinguishing robot according to a second example embodiment.

FIG. 3 is a schematic diagram showing one example of a laser light to be detected in the fire extinguishing robot according to the second example embodiment.

FIG. 4 is a schematic diagram showing another example of a laser light to be detected in the fire extinguishing robot according to the second example embodiment.

FIG. 5 is a schematic diagram showing another example of a laser light to be detected in the fire extinguishing robot according to the second example embodiment and an example of an actual instruction with the laser light.

FIG. 6 is a schematic diagram showing another example of a laser light to be detected in the fire extinguishing robot according to the second example embodiment and an example of an actual instruction with the laser light.

FIG. 7 is a schematic diagram showing another example of a laser light to be detected in the fire extinguishing robot according to the second example embodiment and an example of an actual instruction with the laser light.

FIG. 8 is a schematic diagram showing another example of a laser light to be detected in the fire extinguishing robot according to the second example embodiment and an example of an actual instruction with the laser light.

FIG. 9 shows an example of a reflecting surface to be detected in a fire extinguishing robot according to a sixth example embodiment.

FIG. 10 shows an example of a hardware configuration of a robot.

### DESCRIPTION OF EMBODIMENTS

With reference to drawings, example embodiments are described below. It should be noted that identical numbers refer to identical or like elements in the example embodiments, and repetitive description may be omitted.

### First Example Embodiment

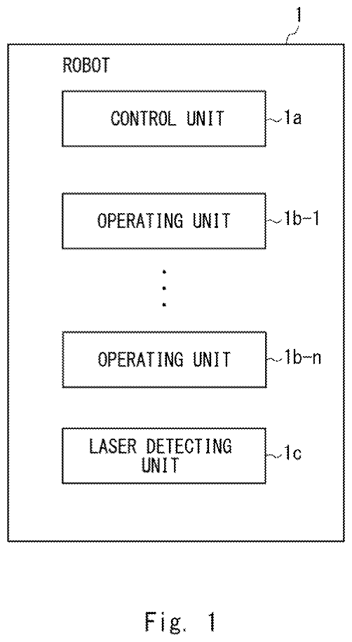

FIG. 1 is a functional block diagram showing one configuration example of a robot according to a first example embodiment.

As shown in FIG. 1, a robot 1 according to this example embodiment includes a control unit 1a that controls the robot 1 overall, n operating units 1b-1 to 1b-n corresponding to n functions, and a laser detecting unit 1c. The control unit 1a can be a controller. The laser detecting unit 1c can be a laser detecting device and can include a laser detecting sensor.

Here, n is an integer equal to or higher than 2. Hereinafter, for description, a representative one of the n operating units is called an operating unit 1b. In other words, the robot 1 includes a plurality of operating units 1b. The operating units 1b correspond to different functions and exerts different functions between a case where one operating unit 1b is operated and a case where another operating unit 1b is operated.

The control unit 1a can be implemented by, for example, a central processing unit (CPU), a working memory, a non-volatile storage device storing a program for controlling the robot 1 overall and so on. It should be noted that the storage device can be configured to function as a storage unit that stores setting information on the robot 1 and so on. The control unit can also be implemented by, for example, an integrated circuit.

The laser detecting unit 1c detects a radiated laser light (laser light radiated to and reflected by some matter such as a building or smoke) and an irradiated location where the radiated laser light is irradiated. The expression “radiated laser light” can refer to a laser light radiated by, for example, a human by using a portable type laser radiating device and may be a laser light rendered as a graphic object by one operation or a laser light rendered as a trace with time. As the portable type laser radiating device, one called a laser pointer may be applied, and, in order to detect a graphical laser light rendered by one operation, a laser pointer of a type that radiates a graphic object by one operation can be used.

As one of main characteristics of this example embodiment, the control unit 1a performs a control that causes different operating units 1b to operate in accordance with an irradiated location detected by the laser detecting unit 1c. It can be said that this control is a control that enables different functions. In other words, the robot 1 is configured to perform operations of different functions in accordance with the irradiated location of the detected laser light.

The operating unit 1b corresponding to one function can be configured by an aggregate of a plurality of operating units, and partial operating units of the aggregate can be a part of an aggregate of other operating units 1b. For example, partial operating units of a plurality of operating units comprising the operating unit 1b-1 can be partial operating units of a plurality of operating units included in the operating unit 1b-n or can be the operating unit 1b-n itself.

As described above, the robot 1 according to this example embodiment can be caused to perform a plurality of different operations with a laser light. As the robot 1, various apparatuses are applicable including a fire extinguishing robot described according to, for example, a second example embodiment below, robots manufactured for other purposes, an aerial vehicle such as a drone, or a mobile body such as an automobile that moves on a road.

Here, an operating method and a program for the robot 1 including the plurality of operating units 1b corresponding to a plurality of functions are supplementarily described. As in the description of the operations of the robot 1, the robot 1 according to this example embodiment can execute an operating method including a detecting step and a control step, which are described below. The detecting step detects a radiated laser light and an irradiated location thereof. The control step performs a control that causes different operating units 1b to operate in accordance with the irradiated location detected by the detecting step. The other examples are as described according to this example embodiment.

It can be said that the aforementioned program is a program for causing a control computer (control unit 1a) of the robot 1 to perform a first step and a second step, which are described below. The first step is one of a step of inputting a detection result of a radiated laser light and detecting an irradiated location where the radiated laser light is irradiated and a step of inputting a detection result of an irradiated location where the radiated laser light is irradiated. The second step is a step of performing a control that causes different operating units 1b to operate in accordance with the irradiated location. The other examples are as described according to this example embodiment.

### Second Example Embodiment

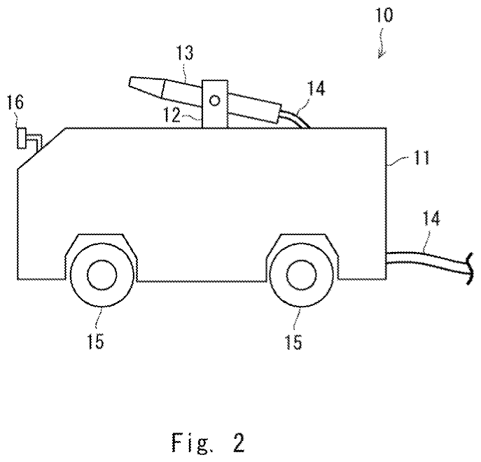

Although a second example embodiment is described with reference to FIGS. 2 to 8 in addition to FIG. 1 and with focus on a difference from the first example embodiment, the various examples described according to the first example embodiment are applicable. FIG. 2 is an external view showing one configuration example of a fire extinguishing robot according to the second example embodiment.

The robot according to this example embodiment is a fire extinguishing robot 10 as shown in FIG. 2. The fire extinguishing robot 10 can include a body unit 11, a fire nozzle mounting base 12, a fire nozzle 13, a hose 14, tires 15, and a camera 16.

For discharging water, the hose 14 can include one end provided in, for example, a reservoir, and the other end attached to the fire nozzle 13. The fire nozzle 13 is mounted on the fire nozzle mounting base 12, and the angle and direction of the water discharging can be changed under control from the body unit 11 side, that is, under control from the control unit 1a. The tires 15 are a part of a moving mechanism (moving unit) that causes the fire extinguishing robot 10 to move, and the directions of the rotation and rotational axis of the tires 15 can be changed under control from the body unit 11 side.

The camera 16 is an example of an image pickup unit and, here, is provided at a part closer to the front side of the body unit 11 so that image pickup can be performed easily. The camera 16 can include a mechanism by which the direction of the image pickup can be changed and can include a zooming function.

The fire extinguishing robot 10 further includes the control unit 1a, the plurality of operating units 1b, and the laser detecting unit 1c, not shown, described according to the first example embodiment. One of the plurality of operating units 1b here is the moving unit including the tires 15, and another one is a water discharging unit exemplarily described mainly as the fire nozzle mounting base 12, the fire nozzle 13 and the hose 14. As a part of the laser detecting unit 1c, the fire extinguishing robot 10 includes the camera 16 in the body unit 11. It should be noted that the parts not shown in FIG. 2 such as the control unit 1a can be provided within the body unit 11.

The control unit 1a according to this example embodiment performs a control that causes different operating units 1b to operate in accordance with a characteristic of an irradiated location detected by the laser detecting unit 1c. Although the aforementioned moving unit and water discharging unit are mainly described below as examples of the different operating units 1b, other operating units may be applied. The characteristic of an irradiated location can also be called an attribute of the irradiated location.

The laser detecting unit 1c can include an analyzing unit that analyzes a characteristic of an irradiated location from an image acquired by the camera 16. Although the analyzing unit can be provided separately from the control unit 1a, the analyzing unit and the control unit 1a can be provided in one control circuit. The analyzing unit can identify an edge or color of the image and can identify a characteristic based on whether the characteristic exists within a plurality of characteristic that have been registered in advance. For example, a road surface can be identified based on the black of asphalt, or a building can be identified otherwise.

Also, the analyzing unit can include artificial intelligent functionality such as a learning model such as a convolutional neural network (CNN) constructed by deep learning, for example. This learning model can be configured to input image data and output a characteristic thereof (such as an attribute indicating one of building, road surface, human and other artifacts). It should be noted that the learning model can be provided externally to the fire extinguishing robot 10 and can be configured to exchange input data and output data through, for example, wireless communication. The analyzing unit can analyze a characteristic by using other methods without limiting to the example as described above.

For performing the wireless communication, the fire extinguishing robot 10 can include a wireless communication unit, not shown. This wireless communication unit can be configured to perform wireless communication based on, for example, a wireless local area network (LAN) standard. Like Bluetooth (registered trademark) and ZigBee (registered trademark), the wireless communication unit can be configured to perform wireless communication based on other wireless communication standards such as IEEE 802.15 standard. For example, the wireless communication unit can be a communication unit that can wirelessly connect to a low power wide area (LPWA) base station by which long-distance data communication is enabled with low consumption current. The LPWA may be LPWA using an individual network or LPWA using a cellular telephone network. Examples of the former LPWA include Long Range Wide Area Network (LoRaWAN, registered trademark), SigFox (registered trademark), and Wi-Fi HaLow (IEEE 802.11ah). Examples of the latter LPWA include Third Generation Partnership Project (3GPP) Long Term Evolution (LTE)-M and 3GPP NB-IoT. NB-IoT stands for Narrow Band-Internet of Things.

The control unit 1a performs a control that causes the water discharging unit to operate or a control that causes the moving unit to operate in accordance with a characteristic of an irradiated location analyzed by the analyzing unit.

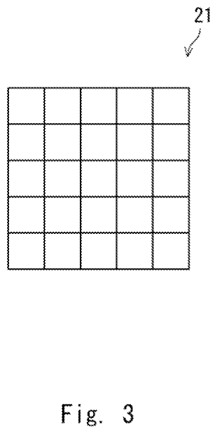

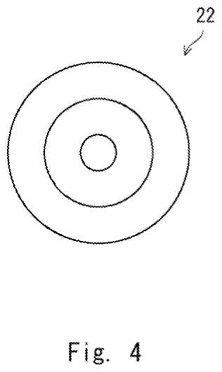

Next, a laser light to be radiated is exemplarily described. FIG. 3 is a schematic diagram showing one example of a laser light to be detected in the fire extinguishing robot according to the second example embodiment, and FIG. 4 is a schematic diagram showing another example of such a laser light.

A laser light can be radiated as a grid image (image in a matrix) 21 shown in FIG. 3. In this case, the laser detecting unit 1c including the camera 16 is configured in advance to be capable of detecting a laser light rendering the grid image 21. The grid image is not limited to have the number of squares or rectangles exemplarily provided in the grid image 21 but may have different numbers of squares or rectangles on the shown right-left side and top-bottom side.

The laser light can be radiated as concentric circles 22 shown in FIG. 4. In this case, the laser detecting unit 1c including the camera 16 is configured in advance to be capable of detecting a laser light rendering the concentric circles 22.

Alternatively, for example, the laser detecting unit 1c can be configured in advance to detect a laser light rendering one of a straight line, an arrow and a cross. It should be noted that the cross may be a diagonal cross. Apparently, the laser detecting unit 1c can be configured to be capable of detecting a shape other than the shapes above and can be configured to detect a plurality of shapes.

The fire extinguishing robot 10 can include a setting unit that sets a shape of a laser light to be detected by the laser detecting unit 1c. The setting unit can separately include an operation unit or can be configured to receive an operation from a terminal such as an external personal computer (PC) or a cellular phone (including one called a smartphone) through a separately provided wireless communication unit. The setting contents can be stored in a memory provided within, for example, the control unit 1a. The setting unit can be configured to set a size of a laser light in addition to or instead of the shape of the laser light.

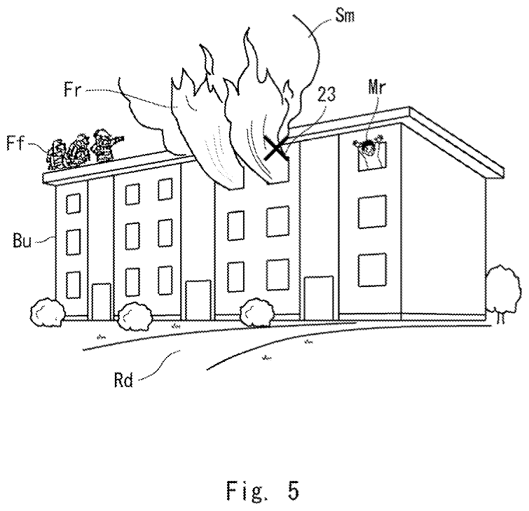

Next, with reference to FIGS. 5 to 8, specific examples of a laser light and so on are described. All of FIGS. 5 to 8 are schematic diagrams showing other examples of a laser light to be detected in the fire extinguishing robot 10 and examples of actual instructions with the laser lights. All of FIGS. 5 to 8 show different examples in which a laser light is radiated to, for example, an actual building.

FIG. 5 shows a situation in which a fire breaks out from a building Bu such as an apartment and flame Fr and smoke Sm are coming out of some windows. It should be noted that FIG. 5 shows a situation in which a resident Mr of the building Bu is left out and firefighters Ff are deployed on the roof.

In this situation, a diagonal-cross-shaped laser light 23 is radiated by a firefighter, not shown, by using a laser pointer from, for example, a front part of the building Bu to a position to which water is to be discharged. The camera 16 captures images including the building Bu and a road Rd in front of the building Bu, and the analyzing unit analyzes a characteristic thereof.

In the example in FIG. 5, the analyzing unit can detect that the laser light 23 is being radiated and, from an image of a surrounding part thereof, a characteristic that the laser light 23 is radiated to a window of the building. By associating the water discharging unit with the window (or the window and flame) in advance in the control unit 1a, the control unit 1a can control the water discharging unit so as to operate based on such a detection result. Therefore, the firefighter can instruct a position to which water is to be discharged by the fire extinguishing robot 10 by using a laser radiating device.

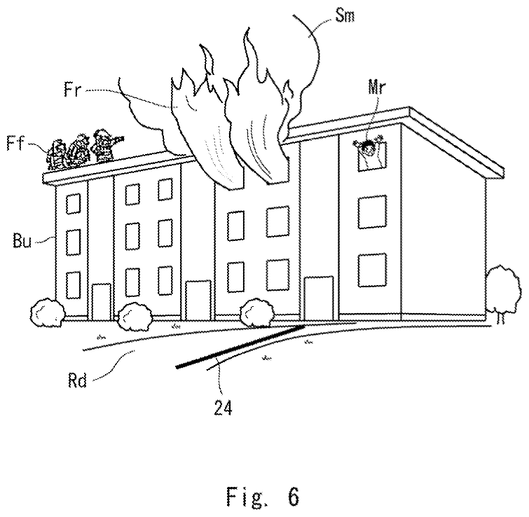

Referring to FIG. 6, in the same situation as that in FIG. 5, a firefighter, not shown, (or the firefighter Ff) causes a laser pointer to radiate a laser light 24 in a straight line toward the road Rd. It should be noted that, although the laser light 24 is drawn in a straight line for easy understanding, the same diagonal cross shape as that of the laser light 23 can be moved from the proximal side to the distal side of the road Rd, for example.

In the example in FIG. 6, the analyzing unit can detect that the laser light 24 is being radiated and, from an image of a surrounding part thereof, a characteristic that the irradiated location is a road. By associating the moving unit with the road in advance in the control unit 1a, the control unit 1a can control so as to cause the moving unit to operate based on such a detection result. More specifically, the control unit 1a can control the moving unit so as to move the fire extinguishing robot 10 along the straight line (or the trace thereof). Therefore, the firefighter can instruct the movement of the fire extinguishing robot 10 by using the laser radiating device.

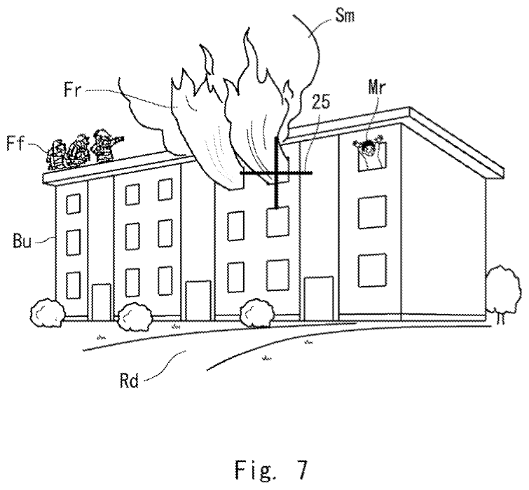

FIG. 7 shows a state that, in the same situation as that of FIG. 5, a larger cross-shaped laser light 25 is radiated if the analyzing unit cannot detect the radiation of the laser light 23. The fact that the radiation of the laser light 23 cannot be detected can be determined by confirming, for example, that water discharging is not performed even though the firefighter causes the radiation of the laser light 23. The firefighter having determined the fact newly causes a larger laser light 25 to be radiated. The direction of the laser light from a laser pointer can be rotated based on the direction of grasping of the laser pointer, without limiting to the example being apparent from the difference between FIG. 5 and FIG. 7.

Then, if the irradiated location cannot be detected, the laser detecting unit 1c changes the shape and/or size of the laser light to be detected. For example, if the laser detecting unit 1c (or the control unit 1a) cannot detect the irradiated location because no laser light can be detected for a predetermined period of time (or if the laser detecting unit 1c can detect the laser light but cannot detect a characteristic of the irradiated location), the shape and/or size to be detected by the laser detecting unit 1c is/are changed. The shape is preferably changed to a shape that can be more easily identified, and the size is preferably changed to be increased.

In the example in FIG. 7, the analyzing unit can detect that the laser light 25 is being radiated and, from an image of a surrounding part thereof, a characteristic that it is a window of the building. As described with reference to the example in FIG. 5, by associating the water discharging unit with the window (or the window and flame) in advance in the control unit 1a, the control unit 1a can control the water discharging unit so as to operate based on such a detection result. Thus, with the laser radiating device, the firefighter can instruct a water discharge position by the fire extinguishing robot 10 by changing the instructing method so as to enable the water discharging.

As described regarding the water discharging to the laser light 23 or 25 and the movement along the laser light 24, the control unit 1a can control the operating unit 1b under control so as to perform an operation in accordance with an irradiated range of the laser light detected by the laser detecting unit 1c. Thus, if the water discharging unit is under control, the water discharge range thereof can be changed to agree with a range including the cross, and, if the moving unit is under control, the moving unit can be caused to move to the range indicated by the straight line.

Like the case where a laser light is radiated to smoke Sm, the laser light irradiated range may be unclear. In order to address such a case, the laser detecting unit 1c can include a calculating unit (range estimating unit) that calculates an irradiated range (a border of the irradiated range) of the radiated laser light. The calculating unit can be provided separately from the control unit 1a, but the calculating unit and the control unit 1a can be provided in one control circuit. Particularly even if the laser light rendering a cross, a grid or concentric circles is radiated to a smoke part or a part having projections and depressions of an object such as clump of trees or a broken window and a part of the laser light is missing, the calculating unit if provided can calculate the irradiated range by performing geometric calculations. In other words, by providing the calculating unit, a laser light can be reproduced by clearly indicating an irradiated range thereof. It should be noted that a learning model can be used also in this calculating unit.

The calculating unit can also be used for identification of an irradiated location. In other words, the control unit 1a can be configured to identify an irradiated location from the calculated irradiated range. For example, the analysis by the laser detecting unit 1c analyzes a characteristic from an image within the calculated irradiated range, and the control unit 1a can be configured to identify the irradiated location based on the analysis result.

The control unit 1a can also control an operation by using a center of an irradiated location instead of the irradiated range. In other words, the control unit 1a can control the operating unit 1b under control so as to perform an operation in accordance with the center of the location irradiated with the laser light detected by the laser detecting unit 1c. Thus, if the water discharging unit is under control, the center of the water discharging operation can be changed to agree with the point of intersection of a cross.

There may be a case where the irradiated range of a laser light is unclear, and, in order to address such a case, the laser detecting unit 1c can include a calculating unit (center estimating unit) that calculates a center of a location irradiated with a radiated laser light. The calculating unit can be provided separately from the control unit 1a, but the calculating unit and the control unit 1a can be provided in one control circuit. Particularly even if the laser light rendering a cross, a grid or concentric circles is partially missing as in the example described above, the calculating unit if provided can calculate the center of the irradiated location by performing geometric calculations. In other words, by providing the calculating unit, a laser light can be reproduced by clearly indicating the center of a location irradiated with the laser light. It should be noted that a learning model can be used also in this calculating unit.

The calculating unit can be used also for identification of an irradiated location. In other words, the control unit 1a can be configured to identify an irradiated location from the calculated center of the irradiated location. For example, the analysis by the laser detecting unit 1c analyzes a characteristic from an image of a predetermined range having the calculated center of the irradiated location as its center, and the control unit 1a can be configured to identify the irradiated location based on the analysis result.

Furthermore, in accordance with a grid shape of a grid image like the grid image 21 exemplarily shown in FIG. 3, the control unit 1a can be configured to perform a control that causes different operating units 1b to operate. The grid shape can be identified based on, for example, an angle of squares or rectangles in the detected grid image.

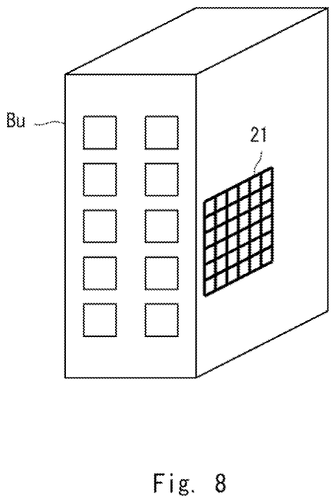

A case where the grid image 21 is radiated to a side wall surface of the building Bu as shown in FIG. 8 is described. In this case, the angle of the rectangles of the grid image 21 is acute. On the other hand, if it is irradiated to the front surface of the building Bu, not shown, the angle of the rectangles is close to 90 degrees. Also when the laser light is radiated to the road surface, the angle of the rectangles of the grid shape is more acute than those on the front surface of the building Bu.

Therefore, if the angle of the rectangles is more acute than a predetermined angle, the control unit 1a can control so as to cause the fire extinguishing robot 10 to move to a location where the fire extinguishing operation can be performed more efficiently, and, if the angle is more obtuse than the predetermined angle, the control unit 1a can control so as to perform a water discharging operation. In this way, the control unit 1a can cause different operating units 1b to operate in accordance with the grid shape. Also in this case, the identification of the irradiated location can be performed by using a result of analysis of an image of a part other than a laser light. Also in the processing for identifying a grid image, a learning model can be used.

The laser detecting unit 1c can be configured in advance to detect a laser light rendering a two-dimensional code such as a QR code (registered trademark, the same is true below). Particularly, as described with reference to the case where the irradiated location cannot be detected, there may be a case where a condition for a projection target is not good. However, if it is good or if the first radiation of a laser light is performed by assuming that it is good, a two-dimensional code can be radiated with the laser light. In the fire extinguishing robot 10, analysis of the two-dimensional code can be performed, and the center position estimation based on an alignment pattern that is one of functions of the two-dimensional code can also be performed. Thus, water can be discharged to a position as designated by the firefighter.

Also in this case, by superposing fine instruction details over the two-dimensional code, a more detailed instruction can be given. In other words, by performing such rendering, the control unit 1a can select an operating unit 1b and control the operating unit 1b selected as a control target by additionally using information included in the rendered image. It should be noted that the laser detecting unit 1c can be configured in advance to detect a laser light rendering a barcode.

The aforementioned fire extinguishing robot 10 can be called a water discharging robot because it includes the water discharging unit. However, the fire extinguishing robot 10 can include a function for spraying a fire extinguishing agent instead of or in addition to the function for spraying water. In other words, instead of or in addition to the water discharging unit, a unit that sprays a fire extinguishing agent can be provided. In the latter case, a control can be performed such that different operating units 1b are associated between the water discharging unit and the unit that sprays a fire extinguishing agent. Examples of the fire extinguishing agent include fire foam and dry chemicals.

As described above, in the fire extinguishing robot 10 according to this example embodiment, like the first example embodiment, a plurality of different operations can be caused to be performed with a laser light, and, in particular, different instructions for an extinguishing operation and a moving operation can be given by changing the irradiated location of a laser light. It should be noted that the various examples described in this example embodiment can be applied to robots other than the fire extinguishing robot except for functionality relating to fire extinguishing operation.

### Third Example Embodiment

A third example embodiment is described with focus on a difference from the first and second example embodiments. However, the third example embodiment can properly apply the various examples described according to the first and second example embodiments.

A system according to this example embodiment (hereinafter, “the system”) is a system including a plurality of robots 1 (or fire extinguishing robots 10) as described above. Therefore, the system can be configured such that those robots 1 operate in conjunction.

In the system, the robots 1 can be configured to be capable of recognizing mutual positions. Furthermore, the control units 1a of the robots can differentiate operations in accordance with the recognized mutual positions. The expression “differentiate operations” refers to differentiating the operating units 1b to be operated or differentiating operating methods such as directions of operation by one operating unit 1b.

For example, the control unit 1a can perform a control that causes the water discharging unit to operate because the robot 1 is the closest to a target to be extinguished or a control to move closer to the target to be extinguished because the robot 1 is farthest away from the target. In this way, the control unit 1a can determine the type of operation or whether the operation is to be performed or not based on a relationship between positions of the other robots, a position where the operation is to be required (such as fire extinguishing position), and the position of the robot 1.

Supplementarily, an example of a method for recognizing mutual positions is described. The plurality of robots 1 are connected by wireless network connection and each includes a positional information obtaining unit so that mutual positional information can be exchanged. As the positional information obtaining unit, an obtaining unit applying a technology such as a global positioning system (GPS), Michibiki (Quasi-Zenith Satellite System) or Wi-Fi (registered trademark) can be used. Alternatively, it can be configured to identify positions of the other robots only based on images captured by an image pickup unit exemplarily provided as the camera 16. This is because the captured images also show the other robots.

The laser detecting unit 1c of each of the robots 1 can also be configured to detect information indicating the robot 1 superposed over a radiated laser light. For example, a command including an ID of the robot 1 can be superposed over the laser light, and each of the robots 1 can operate based on the command including the ID of the robot 1.

With the system, works can be simultaneously instructed by using a laser such that a plurality of robots 1 can autonomously operate. If the robots 1 are fire extinguishing robots, for example, an instruction to move and a designation of a water discharging position can be given separately to each of the fire extinguishing robots. Particularly, since more robotization of dangerous works is expected due to shortage of labor because of future declining of working population, it is advantageous to simultaneously instruct a plurality of robots 1 and cause the robots 1 to autonomously operate as in the system.

### Fourth Example Embodiment

A fourth example embodiment is described with focus on a difference from the first and second example embodiments. However, the fourth example embodiment can properly apply the various examples described according to the first to third example embodiments.

A fire extinguishing robot according to this example embodiment includes a control unit 1a, a fire extinguishing unit that sprays water or a fire extinguishing agent, and a laser detecting unit 1c, like the fire extinguishing robot 10 in FIG. 2 including the configuration of the robot 1 in FIG. 1. However, the laser detecting unit 1c in this example embodiment is only required to detect a radiated laser light. The fire extinguishing robot according to this example embodiment is only required to include the fire extinguishing unit above as one operating unit.

The control unit 1a in this example embodiment controls the fire extinguishing unit so as to spray water or a fire extinguishing agent to a position indicated by a laser light detected by the laser detecting unit 1c.

Also, the fire extinguishing robot according to this example embodiment desirably includes a moving unit that causes the fire extinguishing robot to move. Furthermore, if the position of the laser light detected by the laser detecting unit 1c is a position indicating a road surface, the control unit 1a may control the moving unit so as to move toward the direction indicated by the laser light on the road surface.

An operating method and a program for the fire extinguishing robot including the fire extinguishing unit that sprays water or a fire extinguishing agent are supplementarily described. Like the operations described above, the fire extinguishing robot according to this example embodiment can execute an operating method including a detecting step and a control step, which are described below. The detecting step detects a radiated laser light. The control step controls the fire extinguishing unit so as to spray water or a fire extinguishing agent to a position indicated by the laser light detected by the detecting step. The other examples are as described according to this example embodiment.

It can be said that the program above is a program for causing a control computer of the fire extinguishing robot including the fire extinguishing unit to perform an input step and a control step, which are described blow. The input step inputs a detection result of the radiated laser light. The control step controls the fire extinguishing unit so as to spray water or a fire extinguishing agent to the detected position of the laser light indicated by the detection result input in the input step. The other examples are as described according to this example embodiment.

### Fifth Example Embodiment

A fifth example embodiment is described with focus on a difference from the first example embodiment. However, the fifth example embodiment can properly apply the various examples described according to the first to fourth example embodiments.

A robot according to this example embodiment, like the robot 1 in FIG. 1, includes a control unit 1a, a plurality of operating units 1b corresponding to a plurality of functions, and a laser detecting unit 1c. However, the laser detecting unit 1c in this example embodiment is only required to detect a radiated laser light.

Particularly, the laser detecting unit 1c in this example embodiment detects information embedded in a laser light. The information is embedded on the laser radiating device side and can have a form of a rendered image such as a two-dimensional code such as a QR code, without limiting to an example where the information is embedded by, for example, modulation. The control unit 1a performs a control to cause different operating units 1b to operate in accordance with the information detected by the laser detecting unit 1c.

Also in this example embodiment, a fire extinguishing robot as described in the second example embodiment can be adopted, and, in this case, at least a fire extinguishing unit that sprays water or a fire extinguishing agent and a moving unit that causes the fire extinguishing robot to move can be included as the plurality of operating units 1b.

An operating method and a program for the robot including a plurality of operating units corresponding to a plurality of functions are supplementarily described. As in the description of the operations of the robot, the robot according to this example embodiment can execute an operating method including a detecting step and a control step, which are described below. The detecting step detects a radiated laser light and detects information embedded in the laser light. The control step performs a control that causes different operating units to operate in accordance with the information detected by the detecting step. The other examples are as described according to this example embodiment.

It can be said that the aforementioned program is a program for causing a control computer (control unit 1a) of the robot 1 to execute a first step and a second step, which are described below. The first step is one of a step of inputting a detection result of a radiated laser light and detecting information embedded in the laser light and a step of inputting the information. The second step is a control step of performing a control that causes different operating units to operate in accordance with the information. The other examples are as described according to this example embodiment.

### Sixth Example Embodiment

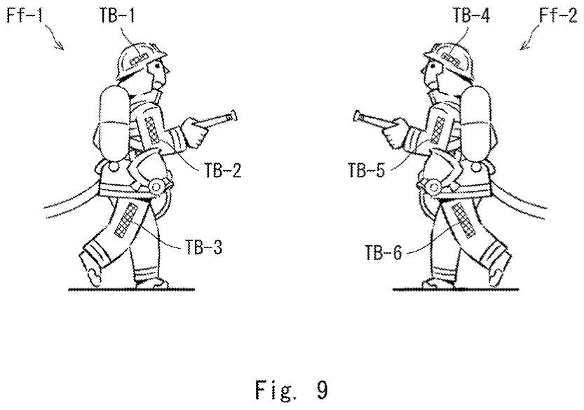

With reference to FIG. 9 additionally, a sixth example embodiment is described with focus on a difference from the fourth example embodiment. FIG. 9 shows an example of a reflecting surface to be detected in a fire extinguishing robot according to the sixth example embodiment. However, the sixth example embodiment can properly apply the various examples described according to the first to fifth example embodiments.

A fire extinguishing robot according to this example embodiment includes a control unit 1a, a fire extinguishing unit that sprays water or a fire extinguishing agent, and a laser detecting unit 1c, like the fire extinguishing robot according to the fourth example embodiment. Also in the fire extinguishing robot according to this example embodiment, the fire extinguishing unit is only required to be provided as one operating unit. However, unlike the fourth example embodiment, the laser detecting unit 1c according to this example embodiment detects a laser light reflected by a reflecting surface having a predetermined shape among the radiated laser lights. Apparently, as described according to the first to fifth example embodiments, a laser light reflected by others than the reflecting surface can be detected.

Particularly, according to this example embodiment, it is assumed that the reflecting surface is provided on individual fire protection equipment (hereinafter, simply called “equipment”) of a firefighter. For example, as shown in FIG. 9, reflecting surfaces TB-1 to TB-6 can be configured by a reflective material such as a fluorescent cloth attached to or embedded in an equipment such as fire-fighting clothing and a helmet of firefighters Ff-1 and Ff-2. Because firefighters are set out to a site where a fire extinguishing robot is required, the reflecting surface TB-1 and so on are provided on their equipment so that the laser detecting unit 1c can detect a laser light reflected by, for example, the reflecting surface TB-1.

Referring to FIG. 9, the reflecting surfaces TB-1, TB-2 and TB-3 are provided on the helmet, the outside of the right arm and the outside of the right leg of the firefighter Ff-1, respectively. The reflecting surfaces TB-4, TB-5 and TB-6 are provided on the helmet, the outside of the left arm and the outside of the left leg of the firefighter Ff-2, respectively. The reflecting surfaces TB-1 and so on have a predetermined shape as described above. Examples of the predetermined shape include a two-dimensional code such as a QR code, but without limiting thereto, the predetermined shape may be a simpler geometric pattern.

The control unit 1a according to this example embodiment identifies a position of the firefighter from a detected position of a laser light detected by the laser detecting unit 1c. The identification of a position can be performed based on, for example, geometric calculations, like the calculation of a center of an irradiated location. In a case where one firefighter has a plurality of reflecting surfaces as in the example in FIG. 9, a position of the firefighter can be identified if a laser light reflected by at least one reflecting surface can be detected. The identified position of the firefighter can be superposed over an electronic map on a terminal such as a PC or a cellular phone. The other firefighters and the leader, for example, can view this for reference for instructing to, for example, change the position of the firefighter.

The reflecting surfaces TB-1 to TB-3 can have an identical shape to each other, and the position of the firefighter Ff-1 can thus be identified if one of the reflecting surfaces can be detected. Similarly, the reflecting surfaces TB-4 to TB-6 can have an identical shape to each other.

The control unit 1a can be configured to determine the presence/absence of a motion of a firefighter from a detected position of a laser light detected by the laser detecting unit 1c. Based on time-series detection results of one or a plurality of reflecting surfaces, the presence/absence of a motion of the firefighter relating to the reflecting surface or reflecting surfaces can be determined. Furthermore, as exemplarily shown in FIG. 9, by providing a plurality of reflecting surfaces to one firefighter, the control unit 1a can determine an attitude of the firefighter based on a positional relationship between the plurality of reflecting surfaces. From the determination result of either or both of them, the control unit 1a can accurately detect that, for example, the firefighter falls over and is disabled to move. Particularly, by additionally using a configuration by which personal information can be detected, which is described below, the control unit 1a can determine the presence/absence of a motion of an individual firefighter.

The reflecting surfaces having shapes (predetermined shapes) different from each other can be provided at least at two positions of a front surface side, a back surface side, a left surface side and a right surface side of a firefighter. For example, the reflecting surfaces TB-1 to TB-3 provided on the right side as exemplarily shown on the firefighter Ff-1 and the reflecting surfaces TB-4 to TB-6 provided on the left side as exemplarily shown on the firefighter Ff-2 can have different shapes. Thus, the detectable reflecting surfaces are different in accordance with the orientation of the firefighter in the right-left direction. Also, by providing similar reflecting surfaces (having different shapes) at the front and back of a firefighter, detectable reflecting surfaces can be differentiated in accordance with whether the firefighter faces the fire extinguishing robot side or the firefighter faces the opposite side.

The control unit 1a can be configured to identify a position and direction of a firefighter based on a laser light detected by the laser detecting unit 1c. Thus, because the direction that the firefighter faces can be identified, the other firefighter or the leader, for example, can easily instruct the firefighter to, for example, move through a wireless communication device by viewing the information on the terminal. Furthermore, the determination of the presence/absence of a motion of the firefighter can thus be easily performed.

In the case where the configuration that also identifies such a direction is adopted, the control unit 1a can further be configured to control the fire extinguishing unit so as to spray water or a fire extinguishing agent to a fire extinguishing position based on the position and direction of a firefighter. For example, the control unit 1a estimates the direction that the eyes of a firefighter are looking and controls the fire extinguishing unit so as to spray, for example, water to a position away from the position of the firefighter by a predetermined distance in the direction (or a part lower by a predetermined angle of the direction) as a fire extinguishing position. Such a fire extinguishing operation can also be performed only when another laser light is radiated to a building at the same time.

The fire extinguishing robot according to this example embodiment also desirably includes a moving unit that causes the fire extinguishing robot to move. The control unit 1a can also control the moving unit so as to move to a moving position based on the identified position and direction of a firefighter. For example, the control unit 1a estimates the direction that the eyes of a firefighter are looking and controls the moving unit such that the fire extinguishing robot moves to a position away from the position of the firefighter by a predetermined distance in the direction. Such a moving operation can also be performed only when another laser light is radiated to a road surface at the same time. The control unit 1a can further be configured to control the fire extinguishing unit if a certain condition is satisfied and control the moving unit if another certain condition is satisfied, based on the identified position and direction.

The aforementioned predetermined shape can include a shape indicating personal information for identifying an individual firefighter (or personal information for identifying his or her role). The laser detecting unit 1c then detects the personal information by, for example, analyzing a detected laser light. Although a two-dimensional code such as a QR code can be used as the predetermined shape, simple geometric shapes can be used if they are differentiated among firefighters.

The control unit 1a can further be configured to perform a control in accordance with the personal information detected by the laser detecting unit 1c. In other words, it can be said that the fire extinguishing robot according to this example embodiment can use information formed as a reflecting surface instead of the information embedded in a laser light as described according to the fifth example embodiment. For example, in a case where the firefighter Ff-1 is specialized in water discharging operations, the firefighter Ff-2 is specialized in rescue operations, and the other firefighters are specialized in operations for, for example, guiding the fire extinguishing robot on a road surface, reflecting surfaces having different shapes between the specialties are provided in advance, and the laser detecting unit 1c detects them. For example, as the control based on personal information, the fire extinguishing unit can be controlled if the detected firefighter is specialized in water discharging operations, and the moving unit can be controlled if he or she is specialized in guiding operations. It should be noted that the control based on personal information is not limited thereto.

An operating method and a program for a fire extinguishing robot including the fire extinguishing unit that sprays water or a fire extinguishing agent are supplementarily described. As in the description of the operations of the fire extinguishing robot, the fire extinguishing robot according to this example embodiment can execute an operating method including a detecting step and a control step, which are described below. The detecting step detects a laser light reflected by a reflecting surface having a predetermined shape provided on individual fire protection equipment of a firefighter. The control step identifies a position of the firefighter from a detected position of the laser light detected by the detecting step. The other examples are as described according to this example embodiment.

It can be said that the aforementioned program is a program for causing a control computer of the fire extinguishing robot including the fire extinguishing unit to perform an input step and a control step, which are described below. The input step inputs a detection result of a laser light reflected by a reflecting surface having a predetermined shape provided on individual fire protection equipment of a firefighter. The control step identifies a position of the firefighter from a detected position of the laser light indicated by the detection result input in the input step. The other examples are as described according to this example embodiment.

### Other Example Embodiments

Having described the functions of the components of the robots according to the aforementioned example embodiments, a robot is only required to implement those functions, and the external shape thereof is not limited to the exemplarily shown ones. Having described that it is assumed that the laser light is emitted from a laser radiating device in response to a command by a human, the laser radiating device (radiating unit that radiates a laser light) can be provided on the robot side or another apparatus side. In a system including a plurality of robots, the laser radiating device can be provided in the one or plurality of robots. A learning model, as described below, can be constructed in advance, and this can be utilized. In other words, the learning model can be a learning model that inputs image data acquired by capturing images of, for example, the site of fire and outputs a location to be irradiated by a laser light from the laser radiating device, a shape of the laser light and so on. With such a learning model, a laser light can be radiated from the laser radiating device mounted in the robot or the like to a proper location to be irradiated.

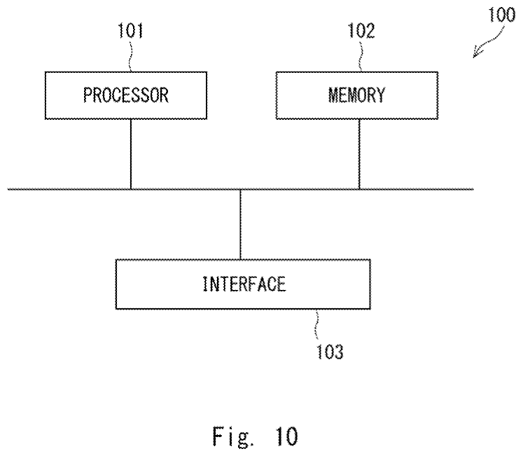

A robot according to each of the example embodiments can include a hardware configuration as described below. FIG. 10 shows an example of a hardware configuration of a robot according to each of the example embodiments.

A robot 100 shown in FIG. 10 includes a processor 101, a memory 102, and an interface 103. The interface 103 can be connected to a detecting device that detects a laser light. A function of each of the units described according to each of the example embodiments can be implemented by reading a program stored in the memory 102 and executing it based on information input from the interface 103 by the processor 101. This program can be the program described according to each of the example embodiments.

In the aforementioned examples, the programs can be stored by using a non-transitory computer-readable medium of various types and can be supplied to a computer. The non-transitory computer-readable medium includes a tangible storage medium of various types. Examples of the non-transitory computer-readable medium include a magnetic recording medium (such as a flexible disk, a magnetic tape or a hard disk drive), a magneto-optical recording medium (such as a magneto-optical disk). Furthermore, the examples include a CD read only memory (ROM), a CD-R, and a CD-R/W. The examples further include a semiconductor memory (such as a mask ROM, a programmable ROM (PROM), an erasable PROM (EPROM), a flash ROM, and a random access memory (RAM)). The aforementioned programs may be supplied to a computer through a transitory computer-readable medium of various types. Examples of the transitory computer-readable medium include an electric signal, an optical signal, and an electromagnetic wave. The transitory computer-readable medium can supply such a program to a computer through a wired communication path such as an electric wire and optical fiber or a wireless communication path.

It should be noted that the present disclosure is not limited to the aforementioned various example embodiments but can be changed as required without departing from the spirit and scope. The present disclosure may be implemented by combining the example embodiments as required.

The whole or part of the exemplary embodiments disclosed above can be described as, but not limited to, the following supplementary notes.

### [Supplementary Notes]

### (Supplementary Note 1)

A robot comprising:

a plurality of operating units corresponding to a plurality of functions;

a laser detecting unit configured to detect a radiated laser light and an irradiated location where the radiated laser light is irradiated; and a control unit,

wherein the control unit performs a control that causes different operating units to operate in accordance with the irradiated location detected by the laser detecting unit.

### (Supplementary Note 2)

The robot according to Supplementary Note 1, wherein the control unit performs a control that causes different operating units to operate in accordance with a characteristic of the irradiated location detected by the laser detecting unit.

### (Supplementary Note 3)

The robot according to Supplementary Note 2, wherein the laser detecting unit includes an image pickup unit and an analyzing unit configured to analyze the characteristic of the irradiated location from an image captured by the image pickup unit.

### (Supplementary Note 4)

The robot according to any one of Supplementary Notes 1 to 3, wherein the control unit controls the operating unit under control so as to perform an operation in accordance with an irradiated range of the laser light detected by the laser detecting unit.

### (Supplementary Note 5)

The robot according to any one of Supplementary Notes 1 to 4, wherein the laser detecting unit includes a calculating unit configured to calculate an irradiated range of the radiated laser light.

### (Supplementary Note 6)

The robot according to any one of Supplementary Notes 1 to 5, wherein the control unit controls the operating unit under control so as to perform an operation in accordance with a center of a location irradiated with the laser light detected by the laser detecting unit.

### (Supplementary Note 7)

The robot according to any one of Supplementary Notes 1 to 6, wherein the laser detecting unit includes a calculating unit configured to calculate a center of a location irradiated with the radiated laser light.

### (Supplementary Note 8)

The robot according to any one of Supplementary Notes 1 to 7, wherein the laser detecting unit detects a laser light rendering a two-dimensional code.

### (Supplementary Note 9)

The robot according to any one of Supplementary Notes 1 to 8, wherein the laser detecting unit detects a laser light rendering one of a straight line, an arrow, a cross and concentric circles.

### (Supplementary Note 10)

The robot according to any one of Supplementary Notes 1 to 8, wherein the laser detecting unit detects a laser light rendering a grid image.

### (Supplementary Note 11)

The robot according to Supplementary Note 10, wherein the control unit performs a control that causes different operating units to operate in accordance with a grid shape of the grid image.

### (Supplementary Note 12)

The robot according to any one of Supplementary Notes 1 to 11, further comprising a setting unit configured to set at least one of a shape and a size of a laser light to be detected by the laser detecting unit.

### (Supplementary Note 13)

The robot according to Supplementary Note 12, wherein the laser detecting unit changes at least one of the shape and the size of the laser light to be detected if the irradiated location cannot be detected.

### (Supplementary Note 14)

The robot according to any one of Supplementary Notes 1 to 13, wherein the robot is a fire extinguishing robot including a function that sprays water or a fire extinguishing agent and a moving function that causes the robot to move.

### (Supplementary Note 15)

A system comprising a plurality of the robots according to any one of Supplementary Notes 1 to 14.

### (Supplementary Note 16)

The system according to Supplementary Note 15, wherein

each of the robots is configured to be capable of recognizing mutual positions, and

the control unit of each of the robots differentiates operations in accordance with recognized mutual positions.

### (Supplementary Note 17)

The system according to Supplementary Note 15 or 16, wherein the laser detecting unit of each of the robots detects information being superposed over the radiated laser light and indicating the robot.

### (Supplementary Note 18)

The system according to any one of Supplementary Notes 15 to 17, further comprising a radiating unit configured to radiate the laser light.

### (Supplementary Note 19)

An operating method for a robot including a plurality of operating units corresponding to a plurality of functions, the operating method comprising:

a detecting step of detecting a radiated laser light and an irradiated location where the radiated laser light is irradiated; and

a control step of performing a control that causes different operating units to operate in accordance with the irradiated location detected by the detecting step.

### (Supplementary Note 20)

A program causing a control computer of a robot including a plurality of operating units corresponding to a plurality of functions to perform:

one step of a step of inputting a detection result of a radiated laser light and detecting an irradiated location where the radiated laser light is irradiated and a step of inputting a detection result of an irradiated location where the radiated laser light is irradiated; and

a step of performing a control that causes different operating units to operate in accordance with the irradiated location.

### (Supplementary Note 21)

A fire extinguishing robot comprising:

a fire extinguishing unit configured to spray water or a fire extinguishing agent;

a laser detecting unit configured to detect a radiated laser light; and

a control unit,

wherein the control unit controls the fire extinguishing unit so as to spray the water or fire extinguishing agent to a position indicated by the laser light detected by the laser detecting unit.

### (Supplementary Note 22)

The fire extinguishing robot according to Supplementary Note 21, further comprising a moving unit configured to cause the fire extinguishing robot to move,

wherein the control unit controls the moving unit so as to move in a direction indicated by the laser light on a road surface if the position of the laser light detected by the laser detecting unit is a position indicating the road surface.

### (Supplementary Note 23)

An operating method for a fire extinguishing robot including a fire extinguishing unit configured to spray water or a fire extinguishing agent, the operating method comprising:

a detecting step of detecting a radiated laser light; and

a control step of controlling the fire extinguishing unit so as to spray the water or fire extinguishing agent to a position indicated by the laser light detected by the detecting step.

### (Supplementary Note 24)

A program for causing a control computer of a fire extinguishing robot including a fire extinguishing unit configured to spray water or a fire extinguishing agent to perform:

an input step of inputting a detection result of a radiated laser light; and

a control step of controlling the fire extinguishing unit so as to spray the water or fire extinguishing agent to a detected position of the laser light indicating the detection result input in the input step.

### (Supplementary Note 25)

A robot comprising:

a plurality of operating units corresponding to a plurality of functions;

a laser detecting unit configured to detect a radiated laser light; and

a control unit, wherein

the laser detecting unit detects information embedded in the laser light, and

the control unit performs a control that causes different operating units to operate in accordance with the information detected by the laser detecting unit.

### (Supplementary Note 26)

The robot according to Supplementary Note 25, wherein the robot is a fire extinguishing robot, the robot further comprising, as the plurality of operating units, at least a fire extinguishing unit configured to spray water or a fire extinguishing agent and a moving unit configured to cause the fire extinguishing robot to move.

### (Supplementary Note 27)

An operating method for a robot including a plurality of operating units corresponding to a plurality of functions, the operating method comprising:

a detecting step of detecting a radiated laser light and detecting information embedded in the laser light; and

a control step of performing a control that causes different operating units to operate in accordance with the information detected by the detecting step.

### (Supplementary Note 28)

A program for causing a control computer of a robot including a plurality of operating units corresponding to a plurality of functions to perform:

one step of a step of inputting a detection result of a radiated laser light and detecting information embedded in the laser light and a step of inputting the information; and

a control step of performing a control that causes different operating units to operate in accordance with the information.

### (Supplementary Note 29)

A fire extinguishing robot comprising:

a fire extinguishing unit configured to spray water or a fire extinguishing agent;

a laser detecting unit configured to detect a laser light reflected by a reflecting surface having a predetermined shape; and

a control unit, wherein

the reflecting surface is provided on individual fire protection equipment of a firefighter, and

the control unit identifies a position of the firefighter from a detected position of the laser light detected by the laser detecting unit.

### (Supplementary Note 30)

The fire extinguishing robot according to Supplementary Note 29, wherein the control unit determines presence/absence of a motion of the firefighter from the detected position of the laser light detected by the laser detecting unit.

### (Supplementary Note 31)

The fire extinguishing robot according to Supplementary Note 29 or 30, wherein

the reflecting surface is provided at least at two positions of a front surface side, a back surface side, a left surface side and a right surface side of the firefighter, and the provided reflecting surfaces have the predetermined shapes different from each other, and

the control unit identifies a position and a direction of the firefighter based on the laser light detected by the laser detecting unit.

### (Supplementary Note 32)

The fire extinguishing robot according to Supplementary Note 31, wherein the control unit controls the fire extinguishing unit so as to spray the water or fire extinguishing agent to a fire extinguishing position based on the position and direction of the firefighter.

### (Supplementary Note 33)

The fire extinguishing robot according to Supplementary Note 31 or 32, further comprising a moving unit configured to cause the fire extinguishing robot to move,

wherein the control unit controls the moving unit so as to move to a moving position based on the position and direction of the firefighter.

### (Supplementary Note 34)

The fire extinguishing robot according to any one of Supplementary Notes 29 to 33, wherein

the predetermined shape includes a shape indicating personal information for identifying an individual firefighter,

the laser detecting unit detects the personal information, and

the control unit performs a control according to the personal information detected by the laser detecting unit.

### (Supplementary Note 35)

An operating method for a fire extinguishing robot including a fire extinguishing unit configured to spray water or a fire extinguishing agent, the operating method comprising:

a detecting step of detecting a laser light reflected by a reflecting surface being provided on individual fire protection equipment of a firefighter and having a predetermined shape, and

a control step of identifying a position of the firefighter from a detected position of the laser light detected by the detecting step.

### (Supplementary Note 36)

A program for causing a control computer of a fire extinguishing robot including a fire extinguishing unit configured to spray water or a fire extinguishing agent to perform:

an input step of inputting a detection result of a laser light reflected by a reflecting surface being provided on individual fire protection equipment of a firefighter and having a predetermined shape, and

a control step of identifying a position of the firefighter from a detected position of the laser light indicated by the detection result input in the input step.

Having described above the present invention with reference to example embodiments, the present invention is not limited to the description above. Various changes that can be understood by those skilled in the art can be made to the configuration and details of the present invention without departing from the scope of the invention.

This application claims the priority based on Japanese Patent Application No. 2019-027468 filed on Feb. 19, 2019, the disclosure of which is incorporated herein in its entirety.

### REFERENCE SIGNS LIST

1, 100 robot
1a control unit
1b, 1b-1, 1b-n operating unit
1c laser detecting unit
10 fire extinguishing robot
11 body unit
12 fire nozzle mounting base
13 fire nozzle
14 hose
15 tire
16 camera
21 grid image
22 concentric circles
23, 24, 25 laser light
101 processor
102 memory
103 interface

What is claimed is:

1. A robot comprising:
a plurality of operating units corresponding to a plurality of functions;
a laser detector configured to detect a radiated laser light and an irradiated location where the radiated laser light is irradiated; and
a controller,
wherein the controller performs a control that causes different operating units to operate in accordance with the irradiated location detected by the laser detector.

2. The robot according to claim 1, wherein the controller performs a control that causes different operating units to operate in accordance with a characteristic of the irradiated location detected by the laser detector.

3. The robot according to claim 2, wherein the laser detector includes a camera and an analyzer configured to analyze the characteristic of the irradiated location from an image captured by the camera.

4. The robot according to claim 1, wherein the controller controls the operating unit under control so as to perform an operation in accordance with an irradiated range of the laser light detected by the laser detector.

5. The robot according to claim 1, wherein the laser detector includes a first calculator configured to calculate an irradiated range of the radiated laser light.

6. The robot according to claim 1, wherein the controller controls the operating unit under control so as to perform an operation in accordance with a center of a location irradiated with the laser light detected by the laser detector.

7. The robot according to claim 1, wherein the laser detector includes a second calculator configured to calculate a center of a location irradiated with the radiated laser light.

8. The robot according to claim 1, wherein the laser detector detects a laser light rendering a two-dimensional code.

9. The robot according to claim 1, wherein the laser detector detects a laser light rendering one of a straight line, an arrow, a cross and concentric circles.

10. The robot according to claim 1, wherein the laser detector detects a laser light rendering a grid image.

11. The robot according to claim 10, wherein the controller performs a control that causes different operating units to operate in accordance with a grid shape of the grid image.

12. The robot according to claim 1, further comprising a setting unit configured to set at least one of a shape and a size of a laser light to be detected by the laser detector.

13. The robot according to claim 12, wherein the laser detector changes at least one of the shape and the size of the laser light to be detected if the irradiated location cannot be detected.

14. The robot according to claim 1, wherein the robot is a fire extinguishing robot including a function that sprays water or a fire extinguishing agent and a moving function that causes the robot to move.

15. A system comprising a plurality of the robots according to claim 1.

16. The system according to claim 15, wherein
each of the robots is configured to be capable of recognizing mutual positions, and
the controller of each of the robots differentiates operations in accordance with recognized mutual positions.

17. The system according to claim 15, wherein the laser detector of each of the robots detects information being superposed over the radiated laser light and indicating the robot.

18. The system according to claim 15, further comprising an irradiator configured to radiate the laser light.

19. An operating method for a robot including a plurality of operating units corresponding to a plurality of functions, the operating method comprising:
detecting a radiated laser light and an irradiated location where the radiated laser light is irradiated; and
performing a control that causes different operating units to operate in accordance with the irradiated location detected by the detecting.

20. A non-transitory computer-readable medium storing a program causing a control computer of a robot including a plurality of operating units corresponding to a plurality of functions to perform:
inputting a detection result of a radiated laser light and detecting an irradiated location where the radiated laser light is irradiated or inputting a detection result of an irradiated location where the radiated laser light is irradiated; and
performing a control that causes different operating units to operate in accordance with the irradiated location.

21-36. (canceled)
